(19) United States
(12) Patent Application Publication
(10) Pub. No.: US 2025/0085261 A1
(43) Pub. Date: Mar. 13, 2025

(54) GAS CHROMATOGRAPH ANALYSIS METHOD AND GAS CHROMATOGRAPH ANALYSIS PROGRAM

(71) Applicant: SHIMADZU CORPORATION, Kyoto (JP)

(72) Inventors: Yusuke TAKEMORI, Kyoto-shi (JP); Yui HIGASHI, Kyoto-shi (JP)

(73) Assignee: SHIMADZU CORPORATION, Kyoto (JP)

(21) Appl. No.: 18/727,568

(22) PCT Filed: Oct. 20, 2022
(86) PCT No.: PCT/JP2022/039122

§ 371 Date: Jul. 9, 2024

(30) Foreign Application Priority Data
Jan. 18, 2022 (JP) 2022-005663

(51) Int. Cl. G01N 30/86; G01N 30/02; G01N 30/30; G01N 30/72

(52) U.S. Cl. CPC G01N 30/8631; G01N 30/30; G01N 30/7206; G01N 2030/025

(57) ABSTRACT

One aspect of a GC analysis method according to the present invention is a GC analysis method for detecting a component contained in a sample gas by separating the component in a column, the GC analysis method including: a sample collection step (S1-S3) of collecting a sample gas from a solution containing an n-alkane, which is a reference compound of a retention index, by using a headspace method; a reference compound analysis step (S3) of introducing the sample gas collected in the sample collection step into the column and performing GC analysis; and a retention time calculation step (S4-S5) of obtaining an actually-measured retention time for the n-alkane on the basis of a chromatogram obtained by the GC analysis, and estimating a retention time of a compound to be analyzed from the actually-measured retention time and a known retention index of the compound to be analyzed.

### TECHNICAL FIELD

The present invention relates to an analysis method using a gas chromatograph (GC) and a computer program for performing the analysis method, and more particularly to a GC analysis method and a GC analysis program using a headspace method for introducing a sample into a column. The GC analysis herein includes gas chromatography/mass spectrometry (GC/MS) using a mass spectrometer as a detector.

### BACKGROUND ART

In general, in GC analysis, a retention time (RT) is used to identify a peak observed in a chromatogram. However, a retention time is not a value determined solely by a compound, but it depends on various separation conditions such as a carrier gas flow rate (velocity), a column temperature, and a column length. Therefore, unless the separation conditions in measuring a target sample are identical with the separation conditions in measuring a standard substance or the like when the retention time to be used for identification is obtained, peak identification using the retention time cannot be accurately performed. In many cases, adopting the same separation conditions is substantially impossible. To address the problem, in peak identification in GC analysis, a retention index (RI) which is less likely to depend on separation conditions, individual apparatuses, and the like is often used instead of the retention time. A retention index is obtained by indexing the retention times of various compounds using the retention time of the peak of an n-alkane adopted as a reference compound. The values of the retention indices of many compounds are widely known.

As described in Non Patent Literature 1, a conventional GC has a function of estimating the retention time of a compound to be analyzed from the known retention index of the compound to be analyzed, the retention index of the above reference compound, and a retention time obtained by actually measuring the reference compound, and adjusting the retention time of the compound to be analyzed previously registered in the GC by using the estimated value. In the apparatus described in Non Patent Literature 1, the function is called automatic adjustment of retention time (AART). As a result, even in a case where a separation condition is changed, such as a part of a column being cut due to contamination of the column, for example, the retention time of the compound to be analyzed before the change of the separation condition can be accurately adjusted to an appropriate value after the change. This makes it possible to improve the accuracy of identification of the compound to be analyzed using the retention time.

In order to use the automatic adjustment of retention time function as described above, it is necessary for a user to actually measure the reference compound in the apparatus used. Usually, when the reference compound is measured, a predetermined amount of standard sample containing the reference compound is injected into a sample vaporization chamber provided at the end of a column inlet manually or by using an auto injector. The standard sample of an n-alkane, which is a reference of the retention index, contains a wide variety of linear alkanes with several to 30 or more carbon atoms, and has a considerably wide range of boiling points. Because a sample is vaporized at a high temperature of about 200° C. or higher in the sample vaporization chamber, the wide variety of linear alkanes can be satisfactorily vaporized and sent into the column.

### CITATION LIST

### Non Patent Literature

Non Patent Literature 1: “Automatic Adjustment of Retention Time, and Input of Retention Index”, [online], [searched on Dec. 23, 2021], Shimadzu Corporation, Internet <URL: https://www.an.shimadzu.co.jp/gcms/support/faq/gcmssol/faq12.htm>
Non Patent Literature 2: “Headspace Sampler HS-20 NX Series”, [online], [searched on Dec. 23, 2021], Shimadzu Corporation, Internet <URL: https://www.an.shimadzu.co.jp/gc/hs-20nx/c180-0214.pdf> (first edition issued on June 2021)

### SUMMARY OF INVENTION

### Technical Problem

A headspace (HS) method is one of sample introduction methods in GC analysis. In the HS method, a liquid sample or a solid sample contained in a sealed sample container is heated to a certain temperature for a certain period of time to volatilize components in the sample, and a certain amount of sample gas containing the components is collected from an upper space in the sample container and introduced into a column. In the HS method, unlike the sample introduction method using a sample vaporization chamber, components can be volatilized and collected at a relatively low temperature close to normal temperature. For example, many of aroma components in foods and drinks and smell components of chemical products are compounds having a low boiling point, that is, having high volatility. For such samples, sample introduction using the HS method enables aroma components or the like to be analyzed to be efficiently introduced into the column, whereas impurities having a high boiling point, which are not to be analyzed, are less likely to be introduced into the column. This makes it possible to perform good analysis by removing impurities.

For example, in a case where a smell component or the like in a sample is analyzed by combining a headspace sampler described in Non Patent Literature 2 or the like and a GC, measurement using the HS method is performed for a target sample, and measurement is performed for a standard sample containing n-alkanes by injecting the sample into a sample vaporization chamber provided at an inlet of a column. The retention time of a compound to be analyzed (smell component) is adjusted using the measurement result for the standard sample. However, when different sample introduction methods are used, the retention time for the same compound may be different even under exactly the same separation conditions other than the sample introduction method. Thus, there is a concern that the accuracy of adjustment of the retention time deteriorates. When the adjustment accuracy of the retention time deteriorates, there is a possibility that the accuracy of peak identification, that is, compound identification lowers. In addition, there is also a possibility that an unknown compound contained in the sample is overlooked.

The present invention has been made in view of such problems, and an object of the present invention is to perform compound identification using retention times corresponding to various compounds in a sample with high accuracy in a GC analysis method in which sample introduction is performed by the HS method.

### Solution to Problem

One aspect of a GC analysis method according to the present invention made to solve the above problems is a GC analysis method for detecting a component contained in a sample gas by separating the component in a column, the GC analysis method including:
a sample collection step of collecting a sample gas from a solution containing an n-alkane, which is a reference compound of a retention index, by using a headspace method;
a reference compound analysis step of introducing the sample gas collected in the sample collection step into the column and performing GC analysis; and
a retention time calculation step of obtaining an actually-measured retention time for the n-alkane on the basis of a chromatogram obtained by the GC analysis in the reference compound analysis step, and estimating a retention time of a compound to be analyzed from the actually-measured retention time and a known retention index of the compound to be analyzed.

One aspect of a GC analysis program according to the present invention made to solve the above problems is a GC analysis program for controlling a system including a headspace sampler and a measurement unit configured to detect a component contained in a sample gas by separating the component in a GC column, the GC analysis program causing a computer to execute;
a reference compound measurement condition setting step of displaying, upon receiving an operation by a user, an image on a screen for allowing a setting of a measurement condition including a vial oven temperature for measuring n-alkane, which is a reference compound of a retention index, and receiving the setting by the user on the screen;
a reference compound measurement step of controlling the headspace sampler and the measurement unit according to the setting of the measurement condition set in the reference compound measurement condition setting step to perform GC analysis on the n-alkane prepared in a vial; and
a retention time adjustment step of obtaining an actually-measured retention time for the n-alkane on the basis of a chromatogram obtained by the GC analysis in the reference compound measurement step, estimating a retention time of a compound to be analyzed from the actually-measured retention time and a known retention index of the compound to be analyzed, and adjusting a retention time of the compound in a compound table which describes information on the compound to be analyzed.

### Advantageous Effects of Invention

According to the above aspect of the GC analysis method and the GC analysis program according to the present invention, the n-alkane which is a reference compound is also subjected to the GC analysis using the HS method in the same manner as the compound to be analyzed, so that the retention time of the compound to be analyzed is acquired or adjusted with high accuracy. This makes it possible to identify the compound to be analyzed using the retention time with high accuracy. In addition, there is no need to change the system configuration between the measurement of the reference compound and the measurement of the compound to be analyzed as in the related art, specifically, there is no need to attach/detach the headspace sampler or attach/detach a sample vaporization chamber, and the measurement of the reference compound and the measurement of the compound to be analyzed can be performed in a system having the same configuration. This makes it possible to reduce the workload of a user, and improve the measurement efficiency.

### BRIEF DESCRIPTION OF DRAWINGS

FIG. 1 is a schematic block configuration diagram illustrating an example of a GC-MS system for performing a GC analysis method according to an embodiment of the present invention.

FIG. 2 is a flowchart illustrating a procedure of identification of a compound to be analyzed including a retention time automatic adjustment process in the GC-MS system illustrated in FIG. 1.

FIG. 3 is a flowchart illustrating a procedure for measuring a reference compound.

### DESCRIPTION OF EMBODIMENTS

An embodiment of a GC analysis method and a computer program for performing the GC analysis method according to the present invention will be described with reference to the accompanying drawings.

### [Configuration of GC-MS System]

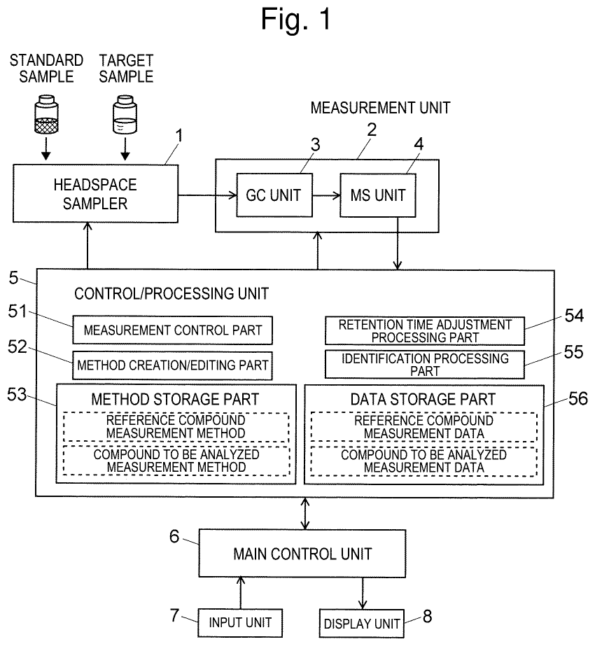

FIG. 1 is a schematic block configuration diagram illustrating an example of a GC-MS system for performing the GC analysis method of the present embodiment.

The GC-MS system includes a headspace sampler (sometimes abbreviated as HSS) 1, a measurement unit 2 including a gas chromatograph unit (GC unit) 3 and a mass spectrometry unit (MS unit) 4, a control/processing unit 5 that controls each of the headspace sampler 1 and the measurement unit 2 and processes data (mass spectrum data, chromatogram data) obtained by the measurement unit 2, a main control unit 6 that controls the entire system, and an input unit 7 and a display unit 8 that are user interfaces.

Although not illustrated, the headspace sampler 1 includes a vial oven that heats a vial in which a liquid (or solid) is sealed, and a sample collection part including a syringe that sucks and discharges a predetermined amount of sample gas from a headspace in the vial. In addition, the headspace sampler 1 can include a changer mechanism that selects a large number of previously prepared vials in a fixed (programmed) order and sets them in the vial oven. As the headspace sampler 1, for example, a headspace sampler “HS-20 NX series” manufactured by Shimadzu Corporation (see Non Patent Literature 2) can be used.

Although not illustrated, in the measurement unit 2, the GC unit 3 includes a column that separates components in a sample gas, a column oven that controls the temperature of the column, and a gas supply part that supplies a certain flow rate of carrier gas to the column.

The MS unit 4 includes an ion source that momently ionizes the components in the sample gas sent from the GC unit 3, a mass separator such as a quadrupole mass filter that separates ions according to a mass-to-charge ratio (m/z), and a detector that detects the ions. The MS unit 4 may be a mass spectrometer capable of performing MS/MS analysis, such as a triple quadrupole mass spectrometer or a quadrupole time-of-flight mass spectrometer, for example, instead of a single type quadrupole mass spectrometer. In addition, since the important thing here is to perform GC analysis, the measurement unit 2 may be a GC using various detectors other than the mass spectrometer, instead of the GC-MS.

The control/processing unit 5 includes functional blocks such as a measurement control part 51, a method creation/editing part 52, a method storage part 53, a retention time adjustment processing part 54, an identification processing part 55, and a data storage part 56. The method storage part 53 stores at least a reference compound measurement method and a compound to be analyzed measurement method. In addition, the data storage part 56 stores at least reference compound measurement data and compound to be analyzed measurement data.

The control/processing unit 5 and the main control unit 6 can be configured using a personal computer as a hardware resource, with their respective functions realized by running, on the computer, a dedicated control/processing software (computer program) installed on the computer.

The computer program may be a software in which the whole program is integrated into one package. However, the computer program can usually include a plurality of softwares such as a software for basic control/processing that controls each of the headspace sampler 1 and the measurement unit 2 and processes data obtained by the measurement unit 2, and a method package that is a software including methods such as a compound table including information on various compounds for a specific purpose, for example, for residual agricultural chemical tests, for metabolites, or the like, and measurement/analysis conditions for the measurement and analysis processing.

In addition, the above computer program can be provided to a user by being stored in a non-transitory computer-readable recording medium such as a CD-ROM, a DVD-ROM, a memory card, or a USB memory (dongle). In addition, the above program can be provided to a user in the form of data transfer via a communication line such as the Internet. Furthermore, the above program can be pre-installed in a computer which is a part of the system (strictly, a storage device which is a part of the computer) when the user purchases the system.

The above GC-MS system can perform identification (qualitative) and quantitative determination of various compounds in a sample. As an example, for the case of identifying various compounds related to a smell to evaluate the smell of a sample such as a food and drink, the sequence of procedure and processing performed in the system will be described. The “smell” mentioned herein is a smell in a broad sense including aroma and odor.

In many cases, compounds related to a smell (hereinafter, referred to as “smell-related compound”) are compounds that easily volatilize at a relatively low temperature (normal temperature or a temperature slightly higher than the normal temperature). On the other hand, usually, the sample contains compounds not related to a smell at all in addition to such smell-related compounds. In order to accurately evaluate the smell, it is desirable to qualitatively and quantitatively determine the smell-related compounds while eliminating the compounds not related to the smell as much as possible. In the HS method, heating can be performed over a wide temperature range from a relatively low temperature to a high temperature. The HS method is thus a sample collection method that meets the above object, and is suitable for detecting a trace amount of smell-related compounds in the sample with high sensitivity.

Here, in order to comprehensively analyze the smell-related compounds, a method package including methods such as a compound table including information on various smell-related compounds and analysis conditions for the analysis is used. The reference compound measurement method and the compound to be analyzed measurement method stored in the method storage part 53 are provided as a part of the method package. In addition, a compound table included in the compound to be analyzed measurement method describes information necessary for measurement, identification, and the like of compounds, such as a mass, a retention time, a retention index, and an m/z value, for each of various compounds to be analyzed (here, smell-related compounds).

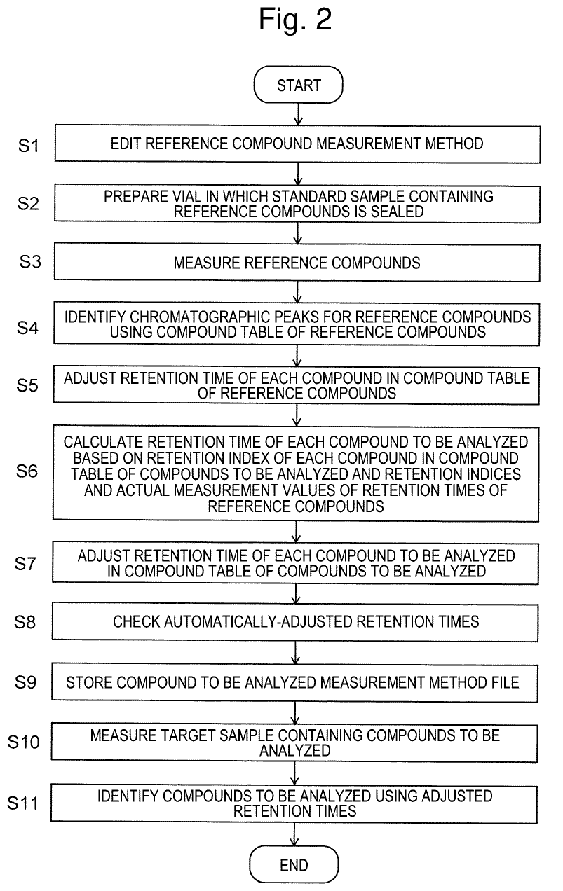

At the time of identification of smell-related compounds in a target sample, a retention time automatic adjustment process is performed as described below before measurement of the target sample, for example. FIG. 2 is a flowchart illustrating a procedure of identification including the retention time automatic adjustment process of compounds to be analyzed in the above GC-MS system.

In order to perform measurement on reference compounds, a user first creates a measurement method of the reference compounds (step S1). Here, since the reference compound measurement method is stored in the method storage part 53 as a part of the method package, the user substantially performs only the work of correcting a part of measurement conditions and the like as necessary as described later. After that, the user prepares a vial in which a solution containing n-alkanes as the reference compounds is sealed, as a measurement sample according to the measurement conditions (step S2).

The user loads the prepared vial into the headspace sampler 1 and performs a predetermined operation using the input unit 7. As a result, the measurement control part 51 controls each of the headspace sampler 1 and the measurement unit 2 according to the reference compound measurement method stored in the method storage part 53 to execute measurement (GC/MS analysis) of the n-alkanes as the reference compounds (step S3).

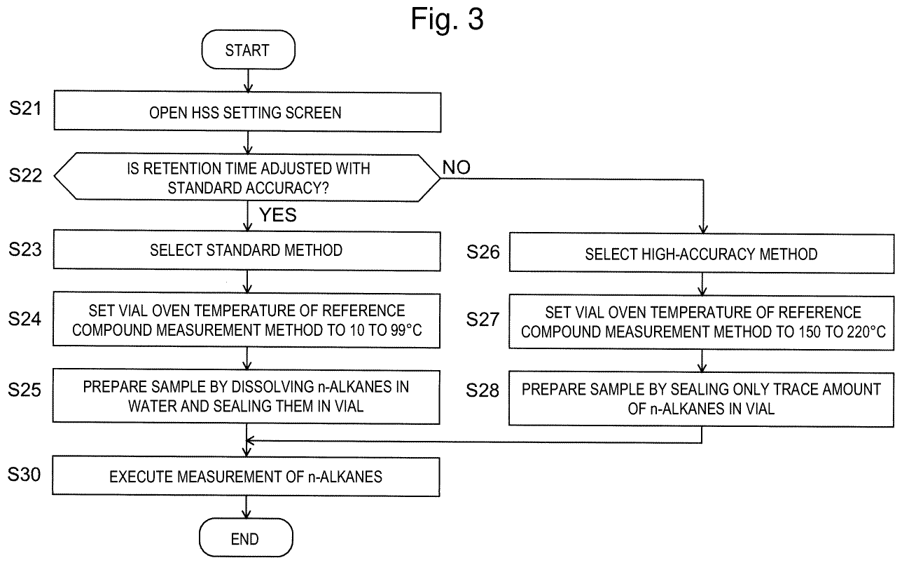

FIG. 3 is a flowchart illustrating a detailed procedure of processing corresponding to steps S1 to S3 described above. An example of the procedure in steps S1 to S3 will be described in detail with reference to FIG. 3.

When performing the measurement by the HS method using the headspace sampler 1, the user selects one of two sample introduction methods in the reference compound measurement method. The two sample introduction methods are a standard method and a high-accuracy method, a difference of which will be described later.

The user performs a predetermined operation using the input unit 7 to open a headspace sampler (HSS) setting screen (step S21). In a case where the user wants to perform the retention time adjustment process with standard accuracy using the measurement result of the reference compounds (Yes in step S22), the user selects the standard method on the setting screen (step S23). On the other hand, in a case where the user wants to adjust the retention times of compounds to be analyzed with high accuracy using the measurement result of the reference compounds (No in step S22), the user selects the high-accuracy method on the setting screen (step S26).

In the case of selecting the standard method, the user sets the temperature of the vial oven, which is one of important measurement conditions in the headspace sampler 1, to an appropriate temperature value within a range of 10 to 99° C. in many cases, within a range of 40 to 80° C. and more preferably within a range of 40 to 60° C. (step S24). The method creation/editing part 52 receives the set temperature value as a part of the reference compound measurement method, and stores the temperature value in the method or in association with the method. After that, the user dissolves a predetermined amount of n-alkane standard sample in a predetermined amount of water, and seals the solution in a vial to prepare a measurement sample (step S25). That is, in this case, the measurement sample prepared in step S2 described above is obtained by dissolving the standard sample in water.

On the other hand, in the case of selecting the high-accuracy method instead of the standard method, the user sets the temperature of the vial oven to an appropriate temperature value within a range of 150 to 220° C. (step S27). The method creation/editing part 52 receives the set temperature value as a part of the reference compound measurement method, and stores the temperature value in the method or in association with the method. After that, the user seals a trace amount (for example, about 1 to 2 μL) of n-alkane standard sample in a vial to prepare a measurement sample (step S28). That is, in this case, the measurement sample prepared in step S2 described above is not dissolved in water but is a trace amount of pure standard sample.

Subsequently, the user gives an instruction to start executing the measurement, for example, using the input unit 7. Under the control of the measurement control part 51 that has received the instruction, the headspace sampler 1 heats the vial to the instructed vial oven temperature and maintains the temperature for a predetermined time. A part of the sample gas containing the n-alkanes filling the inner space of the vial is introduced into the GC unit 3 along with the flow of a carrier gas. While the sample gas is passing through the column of the GC unit 3, the n-alkanes in the gas are temporally separated according to the carbon number. The MS unit 4 sequentially detects the n-alkanes temporally separated in the GC unit 3, and outputs detection signals according to the concentration. The measurement data obtained for the n-alkanes is stored in the data storage part 56 in the control/processing unit 5.

Here, a difference between the standard method and the high-accuracy method will be described.

The n-alkane standard sample contains a wide variety of linear alkanes with several to 30 or more carbon atoms. As an example, “Qualitative Retention Time Index Standard” sold by GL Sciences Inc. contains n-alkanes with different carbon numbers from C7 to C33. The higher the boiling point of the linear alkane, the larger the carbon number. A temperature of 200° C. or higher is required to volatilize all the linear alkanes contained in the standard sample.

Many of smell-related compounds as the compounds to be analyzed in the present example are low-boiling-point compounds that easily volatilize at normal temperature. On the other hand, the sample containing the smell-related compounds also contains many impurities having a relatively high boiling point. Therefore, in order to measure the smell-related compounds with high sensitivity and accuracy, it is desirable to use the HS method at a relatively low temperature at which the smell-related compounds volatilize but most of the impurities do not volatilize, specifically, at a temperature of, for example, about 10 to 99° C. (typically, about 40 to 60° C.).

In a case where the HS method is used at a high temperature of 200° C. or higher in measuring the standard sample containing the n-alkanes, it is necessary to wait until the vial oven temperature of the headspace sampler 1 decreases in order to measure the target sample subsequent to the measurement of the standard sample, which is a wasteful standby time, and lowers the analysis efficiency. On the other hand, when the HS method is used at about the same temperature in measuring the standard sample containing the n-alkanes as that in measuring the target sample, there is no wasteful standby time, and the analysis efficiency can be enhanced.

That is, in a case where emphasis is placed on the analysis efficiency, it is preferable to perform measurement by the standard method in which the vial oven temperature is low, rather than the high-accuracy method. In this case, in order to easily vaporize the n-alkanes at a low temperature, it is desirable to dissolve the standard sample in water instead of directly using the standard sample. In the standard method, only linear alkanes with a smaller carbon number than about C16 in the standard sample are volatilized. Thus, the chromatographic peaks of linear alkanes with a large carbon number having a longer retention time than those of such linear alkanes cannot be used for the retention time adjustment process. Therefore, the estimation accuracy of the retention times of compounds to be analyzed having a relatively long retention time may be slightly lowered. In many cases, however, such lowering in accuracy is practically acceptable.

On the other hand, for example, in a case where the compounds to be analyzed having a relatively long retention time are important, it is sometimes required to adjust the retention times of such compounds to be analyzed with high accuracy in order to accurately identify the compounds. In this case, measurement by the high-accuracy method can be selected instead of the standard method. In a case where a vial containing a certain amount of water is heated to about 200° C. in the HS method, bumping may occur. To address the problem, in the high-accuracy method, it is desirable to directly store a trace amount of standard sample in the vial without dissolving the standard sample in water.

In the high-accuracy method, as described above, the heating temperature of the vial in the HS method is greatly different between the measurement of the n-alkanes and the measurement of the target sample. Thus, there is a disadvantage that a wasteful standby time is required to lower the vial oven temperature of the headspace sampler 1. On the other hand, chromatographic peaks derived from almost all the linear alkanes contained in the standard sample can be used to estimate the retention times of the compounds to be analyzed. Thus, there is an advantage that the retention times of the compounds to be analyzed can be estimated and adjusted with high accuracy.

Returning to FIG. 2, the description is resumed from step S4. As described above, when the measurement of the n-alkanes as the reference compounds is completed and the measurement data is stored in the data storage part 56, the retention time adjustment processing part 54 creates a chromatogram based on the reference compound measurement data and detects a peak in the chromatogram. The chromatographic peaks of the n-alkanes are identified using a compound table of the reference compounds included in the reference compound measurement method (step S4). Furthermore, the retention time adjustment processing part 54 acquires the retention time of each identified chromatographic peak, and adjusts the retention time of each n-alkane in the compound table of the reference compounds to its actual measurement value (step S5). As a result, the retention times in the compound table of the reference compounds reflect the latest measurement conditions. For example, even in a case where the column length has changed from the previous measurement due to cutting of the column or the like, the retention times are adjusted to retention times reflecting the changed column length.

Next, the retention time adjustment processing part 54 reads a compound table of the compounds to be analyzed included in the compound to be analyzed measurement method stored in the method storage part 53, and estimates the retention time of each compound to be analyzed using the retention index of each compound to be analyzed in the compound table, and the retention index and the actual measurement value of the retention time of each reference compound in the above compound table of the reference compounds (step S6). The retention time of each compound to be analyzed in the compound table of the compounds to be analyzed is adjusted on the basis of the estimation result (step S7).

The method of calculating the retention time is the same as that in the conventional retention time automatic adjustment process described in Non Patent Literature 1 and the like.

Specifically, in a case where the peak of a compound to be analyzed is present between the peak of an n-th linear alkane and the peak of an (n+1)-th linear alkane on the chromatogram, the retention time of the compound to be analyzed can be calculated using the following formula (1).

$${RT}_{T} = {RT}_{vn} + ( {RT}_{vn + 1} - {RT}_{vn} ) \times \{ ( {RI}_{T} - {RI}_{vn} ) / ( {RI}_{vn + 1} - {RI}_{vn} ) \} \qquad ( 1 )$$

RT_{T}: Retention time of compound to be analyzed
RI_{T}: Retention index of compound to be analyzed
RTᵥₙ: Retention time of n-th reference compound (actual measurement value)
RIᵥₙ: Retention index of n-th reference compound
RTᵥₙ₊₁: Retention time of (n+1)-th reference compound (actual measurement value)
RIᵥₙ₊₁: Retention index of (n+1)-th reference compound

For example, suppose that the chromatographic peaks of some of the reference compounds are not detected because the above standard method is used at the time of measuring the reference compounds, and thus there are no peaks of reference compounds between which the compound to be analyzed is present. In this case, the retention time may be calculated assuming that the peaks of reference compounds are present at an interval between the retention times and retention indices of two reference compounds temporally closest to the compound to be analyzed.

If necessary, the user checks the retention times automatically adjusted as described above on the screen of the display unit 8 (step S8). Upon receiving an instruction from the user via the input unit 7, the method creation/editing part 52 causes the method storage part 53 to store the file of the compound to be analyzed measurement method including the compound table in which the retention times have been adjusted (step S9).

Subsequently, the measurement control part 51 controls each of the headspace sampler 1 and the measurement unit 2 according to the compound to be analyzed measurement method stored in the method storage part 53 in response to the user performing a predetermined operation, to perform measurement (GC/MS analysis) on the target sample (step S10). In this measurement, the vial oven temperature in the headspace sampler 1 is set within a range of 10 to 99° C. The data storage part 56 stores the measurement data obtained by the GC/MS analysis on the target sample.

After that, the identification processing part 55 creates a chromatogram based on the compound to be analyzed measurement data stored in the data storage part 56, and detects a peak in the chromatogram. The compounds to be analyzed are identified by identifying a chromatographic peak derived from each compound to be analyzed using the compound to be analyzed table in which the retention times have been adjusted (step S11).

The identification process uses the retention times adjusted using the measurement result of the reference compounds obtained by the measurement by the HS method similar to that in the measurement of the target sample, so that each compound can be identified with higher accuracy as compared with the case of using the retention times calculated on the basis of the measurement result of the reference compounds obtained by measurement by the sample introduction method using a sample vaporization chamber. This makes it possible to avoid a situation in which identification becomes impossible even though a compound is detected, or an identification error occurs.

It should be noted that the GC analysis method and the GC analysis program in the above description are merely an example of the present invention. Any modification, change, or addition appropriately made within the spirit of the present invention will evidently fall within the scope of claims of the present application.

### [Various Aspects]

A person skilled in the art can understand that the previously described illustrative embodiment is a specific example of the following aspects of the present invention.

(Clause 1) One aspect of a GC analysis method according to the present invention is a GC analysis method for detecting a component contained in a sample gas by separating the component in a column, the GC analysis method including:
a sample collection step of collecting a sample gas from a solution containing an n-alkane, which is a reference compound of a retention index, by using a headspace method;
a reference compound analysis step of introducing the sample gas collected in the sample collection step into the column and performing GC analysis; and
a retention time calculation step of obtaining an actually-measured retention time for the n-alkane on the basis of a chromatogram obtained by the GC analysis performed in the reference compound analysis step, and estimating a retention time of a compound to be analyzed from the actually-measured retention time and a known retention index of the compound to be analyzed.

(Clause 9) One aspect of a GC analysis program according to the present invention is a GC analysis program for controlling a system including a headspace sampler and a measurement unit configured to detect a component contained in a sample gas by separating the component in a GC column, the GC analysis program causing a computer to execute:
a reference compound measurement condition setting step of displaying, upon receiving an operation by a user, an image on a screen for allowing a setting of a measurement condition including a vial oven temperature for measuring n-alkane, which is a reference compound of a retention index, and receiving the setting by the user on the screen;
a reference compound measurement step of controlling the headspace sampler and the measurement unit according to the setting of the measurement condition set in the reference compound measurement condition setting step to perform GC analysis on the n-alkane prepared in a vial; and
a retention time adjustment step of obtaining an actually-measured retention time for the n-alkane on the basis of a chromatogram obtained by the GC analysis performed in the reference compound measurement step, estimating a retention time of a compound to be analyzed from the actually-measured retention time and a known retention index of the compound to be analyzed, and adjusting a retention time of the compound in a compound table which describes information on the compound to be analyzed.

According to the GC analysis method described in Clause 1 and the GC analysis program described in Clause 9, the n-alkane is also subjected to the GC analysis using the headspace method in the same manner as the compound to be analyzed, so that the retention time of the compound to be analyzed is acquired or adjusted with high accuracy. This makes it possible to identify the compound to be analyzed using the retention time with high accuracy. In addition, there is no need to change the system configuration between the measurement of the reference compound and the measurement of the compound to be analyzed as in the related art, specifically, there is no need to attach/detach the headspace sampler or attach/detach a sample vaporization chamber in a GC, and the measurement of the reference compound and the measurement of the compound to be analyzed can be performed in a system having the same configuration. This makes it possible to reduce the workload of a user, and improve the measurement efficiency.

(Clause 2) In the GC analysis method according to Clause 1, in the retention time calculation step, a retention time in a compound table which describes information on the compound to be analyzed may be adjusted using the estimated retention time of the compound to be analyzed.

According to the GC analysis method described in Clause 2, for example, the retention time of each compound to be analyzed set on the basis of actual measurement before changing a separation condition such as before cutting the column can be adjusted to an accurate retention time reflecting a latest apparatus state after cutting the column.

(Clause 3) The GC analysis method according to Clause 1 or 2 may further include:
a component to be analyzed analysis step of performing gas chromatograph analysis on a sample gas collected from a target sample by using the headspace method; and
a peak identification step of identifying a peak detected in a chromatogram obtained by the component to be analyzed analysis step by using the retention time estimated or adjusted in the retention time calculation step.

(Clause 10) The GC analysis program according to Clause 9 may further cause a computer to execute:
a component to be analyzed analysis step of performing gas chromatograph analysis on a sample gas collected from a target sample by using the headspace method by controlling the headspace sampler and the measurement unit; and
a peak identification step of identifying a peak detected in a chromatogram obtained by the component to be analyzed analysis step by using the retention time adjusted in the retention time adjustment step.

According to the GC analysis method described in Clause 3 and the GC analysis program described in Clause 10, the compound to be analyzed in the target sample can be accurately identified using accurate retention time information reflecting a latest apparatus state. That is, it is possible to reduce identification errors, identification inability, or identification omission, and to perform highly accurate compound identification.

(Clause 4) In the GC analysis method according to any one of Clauses 1 to 3, in the sample collection step, a container containing a solution obtained by dissolving the n-alkane in water may be heated to a temperature in a range of 10 to 99° C.

By dissolving the n-alkane in water, the n-alkane can be easily volatilized at a relatively low temperature. For foods and drinks, sample collection using the headspace method is often performed at a temperature in a range of about 10 to 99° C. (in many cases, in a range of about 40 to 60° C.). In the GC analysis method described in Clause 4, sample collection using the headspace method for the n-alkane can be performed at about the same temperature as that for the target sample. This makes it possible to perform the GC analysis on the target sample and the GC analysis on the n-alkane with no time between them, and to efficiently identify or quantitatively determine the compound to be analyzed in the target sample.

(Clause 5) In the GC analysis method according to any one of Clauses 1 to 3, in the sample collection step, a container containing a trace amount of the n-alkane may be heated to a temperature in a range of 150 to 220° C.

(Clause 6) In the GC analysis method according to Clause 5, in the sample collection step, the container containing the trace amount of n-alkane may be heated to a temperature in a range of 190 to 210° C.

According to the GC analysis method described in Clause 5 or 6, an n-alkane of C20 or more contained in a typical n-alkane mixed solution can also be detected with sufficient sensitivity, and the retention time of a compound to be analyzed having a retention time close to that of such an n-alkane can be accurately estimated using the identification result of the n-alkane.

(Clause 7) The GC analysis method according to Clause 5 or 6 may further include:
a component to be analyzed analysis step of performing gas chromatograph analysis on a sample gas collected from a target sample by using the headspace method at a temperature in a range of 10 to 99° C.; and
a peak identification step of identifying a peak detected in a chromatogram obtained by the component to be analyzed analysis step by using the retention time estimated or adjusted in the retention time calculation step.

In the GC analysis method described in Clause 7, as described above, the GC analysis for the target sample and the GC analysis for the n-alkane are performed by the headspace method at about the same temperature. As a result, the GC analysis and the GC analysis can be performed substantially continuously with no time between them, and the compound to be analyzed in the target sample can be efficiently identified or quantitatively determined.

(Clause 11) In the GC analysis program according to Clause 9 or 10, in the reference compound measurement condition setting step, a first sample collection mode in which a heating temperature in the headspace sampler is a temperature in a range of 10 to 99° C. and a second sample collection mode in which the heating temperature is a temperature in a range of 150 to 220° C. may be selectable.

As described above, in a case where the heating temperature in the headspace sampler is a temperature in the range of 10 to 99° C., the heating temperature is about the same as the heating temperature in the headspace sampler with respect to the target sample. Thus, the operation can be efficiently performed. However, in this case, an n-alkane with a large carbon number (about C17 or more) in the n-alkane mixed solution is not detected with sufficient sensitivity, which relatively lowers the estimation accuracy of the retention time of a compound to be analyzed having a long retention time. On the other hand, in a case where the heating temperature in the headspace sampler is a temperature in the range of 150 to 220° C., the n-alkane with a large carbon number in the n-alkane mixed solution can also be detected with sufficient sensitivity, so that the retention time of the compound to be analyzed having a long retention time can be accurately estimated. However, in this case, the heating temperature in the headspace sampler is greatly different between the n-alkane and the target sample, which makes it difficult to temporally continuously perform GC analysis on the n-alkane and the target sample, and is disadvantageous in terms of the analysis efficiency.

In the GC analysis program described in Clause 11, a user can select the first sample collection mode in a case where the analysis efficiency is emphasized and the second sample collection mode in a case where the identification accuracy is emphasized rather than the analysis efficiency according to the purpose of the analysis, the type of the target sample, and the like. This makes it possible to easily perform analysis so as to satisfy the user's demand.

(Clause 8) In the GC analysis method according to any one of Clauses 1 to 7, the compound to be analyzed may be a compound related to a smell.

(Clause 12) In the GC analysis program according to any one of Clauses 9 to 11, the compound to be analyzed may be a compound related to a smell.

According to the GC analysis method described in Clause 8 and the GC analysis program described in Clause 12, the smell-related compound generally having high volatility (that is, a low boiling point) can be identified with high accuracy.

### REFERENCE SIGNS LIST

1 . . . Headspace Sampler
2 . . . Measurement Unit
3 . . . Gas Chromatograph Unit (GC Unit)
4 . . . Mass Spectrometry Unit (MS Unit)
5 . . . Control/Processing Unit
51 . . . Measurement Control Part
52 . . . Method Creation/Editing Part
53 . . . Method Storage Part
54 . . . Retention Time Adjustment Processing Part
55 . . . Identification Processing Part
56 . . . Data Storage Part
6 . . . Main Control Unit
7 . . . Input Unit
8 . . . Display Unit

1. A gas chromatograph analysis method for detecting a component contained in a sample gas by separating the component in a column, the gas chromatograph analysis method comprising:
a sample collection step of collecting a sample gas from a solution containing an n-alkane, which is a reference compound of a retention index, by using a headspace method;
a reference compound analysis step of introducing the sample gas collected in the sample collection step into the column and performing gas chromatograph analysis; and
a retention time calculation step of obtaining an actually-measured retention time for the n-alkane on a basis of a chromatogram obtained by the gas chromatograph analysis performed in the reference compound analysis step, and estimating a retention time of a compound to be analyzed from the actually-measured retention time and a known retention index of the compound to be analyzed.

2. The gas chromatograph analysis method according to claim 1, wherein in the retention time calculation step, a retention time in a compound table which describes information on the compound to be analyzed is adjusted using the estimated retention time of the compound to be analyzed.

3. The gas chromatograph analysis method according to claim 1, further comprising:
a component to be analyzed analysis step of performing gas chromatograph analysis on a sample gas collected from a target sample by using the headspace method; and
a peak identification step of identifying a peak detected in a chromatogram obtained by the component to be analyzed analysis step by using the retention time estimated or adjusted in the retention time calculation step.

4. The gas chromatograph analysis method according to claim 1, wherein in the sample collection step, a container containing a solution obtained by dissolving the n-alkane in water is heated to a temperature in a range of 10 to 99° C.

5. The gas chromatograph analysis method according to claim 1, wherein in the sample collection step, a container containing a trace amount of the n-alkane is heated to a temperature in a range of 150 to 220° C.

6. The gas chromatograph analysis method according to claim 5, wherein in the sample collection step, the container containing the trace amount of n-alkane is heated to a temperature in a range of 190 to 210° C.

7. The gas chromatograph analysis method according to claim 5, further comprising:
a component to be analyzed analysis step of performing gas chromatograph analysis on a sample gas collected from a target sample by using the headspace method at a temperature in a range of 10 to 99° C.; and
a peak identification step of identifying a peak detected in a chromatogram obtained by the component to be analyzed analysis step by using the retention time estimated or adjusted in the retention time calculation step.

8. The gas chromatograph analysis method according to claim 1, wherein the compound to be analyzed is a compound related to a smell.

9. A non-transitory computer-readable recording medium containing a gas chromatograph analysis program for controlling a system including a headspace sampler and a measurement unit configured to detect a component contained in a sample gas by separating the component in a gas chromatograph column, the gas chromatograph analysis program causing a computer to execute:
a reference compound measurement condition setting step of displaying, upon receiving an operation by a user, an image on a screen for allowing a setting of a measurement condition including a vial oven temperature for measuring n-alkane, which is a reference compound of a retention index, and receiving the setting by the user on the screen;
a reference compound measurement step of controlling the headspace sampler and the measurement unit according to the setting of the measurement condition set in the reference compound measurement condition setting step to perform gas chromatograph analysis on the n-alkane prepared in a vial; and
a retention time adjustment step of obtaining an actually-measured retention time for the n-alkane on a basis of a chromatogram obtained by the gas chromatograph analysis performed in the reference compound measurement step, estimating a retention time of a compound to be analyzed from the actually-measured retention time and a known retention index of the compound to be analyzed, and adjusting a retention time of the compound in a compound table which describes information on the compound to be analyzed.

10. The non-transitory computer-readable recording medium containing a gas chromatograph analysis program according to claim 9, further causing a computer to execute:
a component to be analyzed analysis step of performing gas chromatograph analysis on a sample gas collected from a target sample by using the headspace method by controlling the headspace sampler and the measurement unit; and
a peak identification step of identifying a peak detected in a chromatogram obtained by the component to be analyzed analysis step by using the retention time adjusted in the retention time adjustment step.

11. The non-transitory computer-readable recording medium containing a gas chromatograph analysis program according to claim 9, wherein in the reference compound measurement condition setting step, a first sample collection mode in which a heating temperature in the headspace sampler is a temperature in a range of 10 to 99° C. and a second sample collection mode in which the heating temperature is a temperature in a range of 150 to 220° C. is selectable.

12. The non-transitory computer-readable recording medium containing a gas chromatograph analysis program according to claim 9, wherein the compound to be analyzed is a compound related to a smell.
